(19) United States
(12) Patent Application Publication
(10) Pub. No.: US 2026/0107001 A1
(43) Pub. Date: Apr. 16, 2026

(54) TEMPLATE TYPE SELECTION FOR VIDEO CODING AND DECODING

(71) Applicant: InterDigital CE Patent Holdings, SAS, Paris (FR)

(72) Inventors: Karam Naser, Mouaze (FR); Antoine Robert, Mezieres sur Couesnon (FR); Philippe Bordes, Laille (FR); Franck Galpin, Thorigne-Fouillard (FR)

(21) Appl. No.: 19/119,884

(22) PCT Filed: Sep. 29, 2023
(86) PCT No.: PCT/EP2023/077042

§ 371 Date: Apr. 10, 2025

(30) Foreign Application Priority Data
Oct. 10, 2022 (EP) 22306519.4

(51) Int. Cl. H04N 19/196; H04N 19/105; H04N 19/176; H04N 19/593

(52) U.S. Cl. CPC H04N 19/196; H04N 19/105; H04N 19/176; H04N 19/593

(57) ABSTRACT

A video coding system may use different types of templates when using template-based prediction modes such as intra template matching prediction mode. The ‘L-shape’ template conventionally used by template-based coding tools may be split into a horizontal ‘above’ (or ‘upper’) template and a vertical ‘left’ template. This allows the encoder to select the appropriate part of the template that better captures statistical properties of the current block and results into improving the coding performance. The use of the type of template is signaled in the encoded data so that the decoder can use the appropriate template for the reconstruction when using a template-based prediction mode such as intra template matching prediction mode.

This application claims the priority to European Application No 22306519.4 filed 10 Oct. 2022, which is incorporated herein by reference in its entirety.

### TECHNICAL FIELD

The disclosure is in the field of video compression, and at least one embodiment relates more specifically to signaling a type of template to be used for template-based coding tools.

### BACKGROUND ART

To achieve high compression efficiency, image and video coding schemes usually employ prediction and transform to leverage spatial and temporal redundancy in the video content. Generally, intra or inter prediction is used to exploit the intra or inter frame correlation, then the differences between the original picture block and the predicted picture block, often denoted as prediction errors or prediction residuals, are transformed, quantized and entropy coded. To reconstruct the video, the compressed data is decoded by inverse processes corresponding to the entropy coding, quantization, transform, and prediction.

### SUMMARY

At least one embodiment provides to the encoder the possibility of using different types of templates for the template-based tools. The ‘L-shape’ template conventionally used by the template-based coding tools may be split into a horizontal ‘above’ (or ‘upper’) template and a vertical ‘left’ template. This allows the encoder to select the appropriate part of the template that better captures statistical properties of the current block. and results into improving the coding performance. The use of the type of template is signaled in the encoded data so that the decoder will use the appropriate template for the reconstruction.

A first aspect is directed to a method comprising, for a current block of a picture, providing an information representative of a type of template to be used by a template-based prediction mode such as an intra template matching prediction mode, the type of template being selected amongst a first template comprising a set of adjacent pixels above the current block or a second template comprising a set of adjacent pixels at the left of the current block or a third template being the combination of the first and the second templates.

A second aspect is directed to a method comprising, for a current block of a picture, selecting a prediction mode and a type of template based on coding cost, predicting a block based on the selected prediction mode and type of template, encoding current block based on the predicted block, and providing coding info for the current block comprising at least an information representative of the use of a template-based prediction mode and an information representative of a type of template according to the first aspect.

A third aspect is directed to a device comprising a processor configured to, for a current block of a picture, select a prediction mode and a type of template based on coding cost, predict a block based on the selected prediction mode and type of template, encode current block based on the predicted block, and provide coding info for the current block comprising at least an information representative of the use of a template-based prediction mode and an information representative of a type of template according to the first aspect.

A fourth aspect is directed to a method comprising, for a current block of a picture, obtaining coding information for the current block comprising at least an information representative of the use of a template-based prediction mode and an information representative of a type of template according to the first aspect, predicting a block based on the prediction mode and type of template, and decoding current block based on the predicted block.

A fifth aspect is directed to a device comprising a processor configured to, for a current block of a picture, obtain coding information for the current block comprising at least an information representative of the use of a template-based prediction mode and an information representative of a type of template according to the first aspect, predict a block based on the prediction mode and type of template, and decode current block based on the predicted block.

A sixth aspect is directed to computer program product including instructions, which, when executed by a computer, cause the computer to carry out the method according to the first, second or fourth aspect.

A seventh aspect is directed to non-transitory computer readable medium storing executable program instructions to cause a computer executing the instructions to perform a method according to the first, second or fourth aspect.

An eighth aspect is directed to bitstream representative of an encoded picture, formatted to include syntax elements indicating the type of template of a current block in accordance with the first aspect.

A ninth aspect is directed to non-transitory computer readable medium storing information representative of an encoded picture, formatted to include syntax elements indicating the type of template of a current block in accordance with the method of the first aspect.

The above presents a simplified summary of the subject matter in order to provide a basic understanding of some aspects of the present disclosure. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description provided below.

### BRIEF SUMMARY OF THE DRAWINGS

The present disclosure may be better understood by consideration of the detailed description below in conjunction with the accompanying figures in which:

FIG. 1 illustrates a block diagram of a video encoder according to an embodiment.

FIG. 2 illustrates a block diagram of a video decoder according to an embodiment.

FIG. 3 illustrates a block diagram of an example of a system in which various aspects and embodiments are implemented.

FIGS. 4A, 4B, 4C illustrate the principles of template based intra mode derivation.

FIG. 5 illustrates the principles of decoder side intra mode derivation.

FIG. 6 illustrates the principles of intra template matching.

FIG. 7 illustrates the principles of template matching.

FIG. 8 illustrates the reference region restrictions for the intra block copy with template matching mode.

FIG. 9A illustrates a flowchart of an example of encoding process for a template-based prediction mode according to at least one embodiment.

FIG. 9B illustrates a flowchart of an example of decoding process for a template-based prediction mode according to at least one embodiment.

FIG. 10 illustrates the type of templates.

FIG. 11 illustrates an example of CTU partitioning with CU decoding order.

FIG. 12 illustrates a flowchart of an example of encoding process using an intra template matching prediction mode according to at least one embodiment.

FIG. 13 illustrates a flowchart of an example of decoding process using an intra template matching prediction mode according to at least one embodiment.

It should be understood that the drawings are for purposes of illustrating examples of various aspects, features and embodiments in accordance with the present disclosure and are not necessarily the only possible configurations. Throughout the various figures, like reference designators refer to the same or similar features.

### DETAILED DESCRIPTION

As will be described in more detail below, a video codec can involve determining a prediction block for a current block based on samples of a selected block, the block being selected in an area of decoded picture information based on a template matching process comprising a comparison of a template associated with the current block to at least one other template associated with at least one other block in an area of decoded picture information. Encoding method, decoding method, encoding apparatus, decoding apparatus based on this principle are described.

Moreover, the present aspects, although describing principles related to particular drafts of VVC (Versatile Video Coding) or to HEVC (High Efficiency Video Coding) specifications, are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

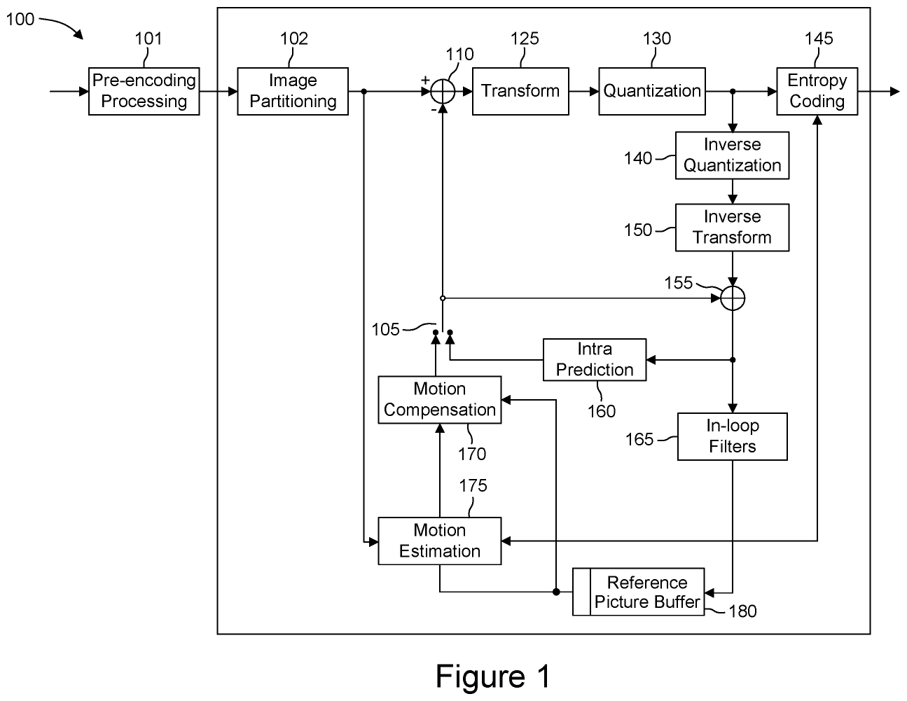

FIG. 1 illustrates a block diagram of a video encoder according to an embodiment. Variations of this encoder 100 are contemplated, but the encoder 100 is described below for purposes of clarity without describing all expected variations. Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset), Adaptive Loop-Filter (ALF) filtering to reduce encoding artifacts. The filtered image is stored at a reference picture buffer (180).

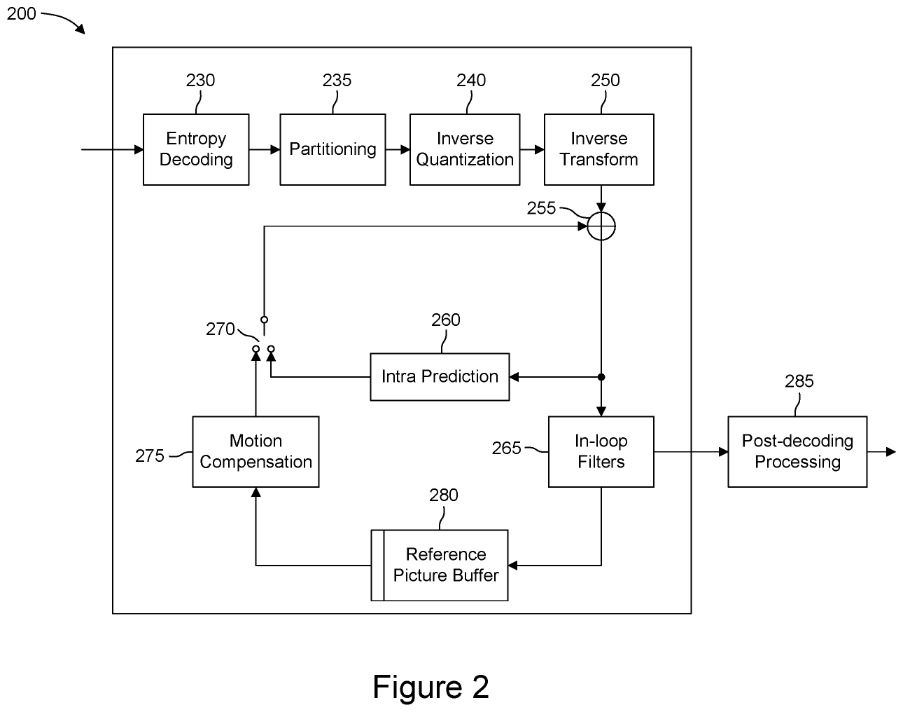

FIG. 2 illustrates a block diagram of a video decoder according to an embodiment. In the decoder 200, a bitstream is decoded by the decoder elements as described below. Video decoder 200 generally performs a decoding pass reciprocal to the encoding pass. The encoder 100 also generally performs video decoding as part of encoding video data. In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240), and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g., conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

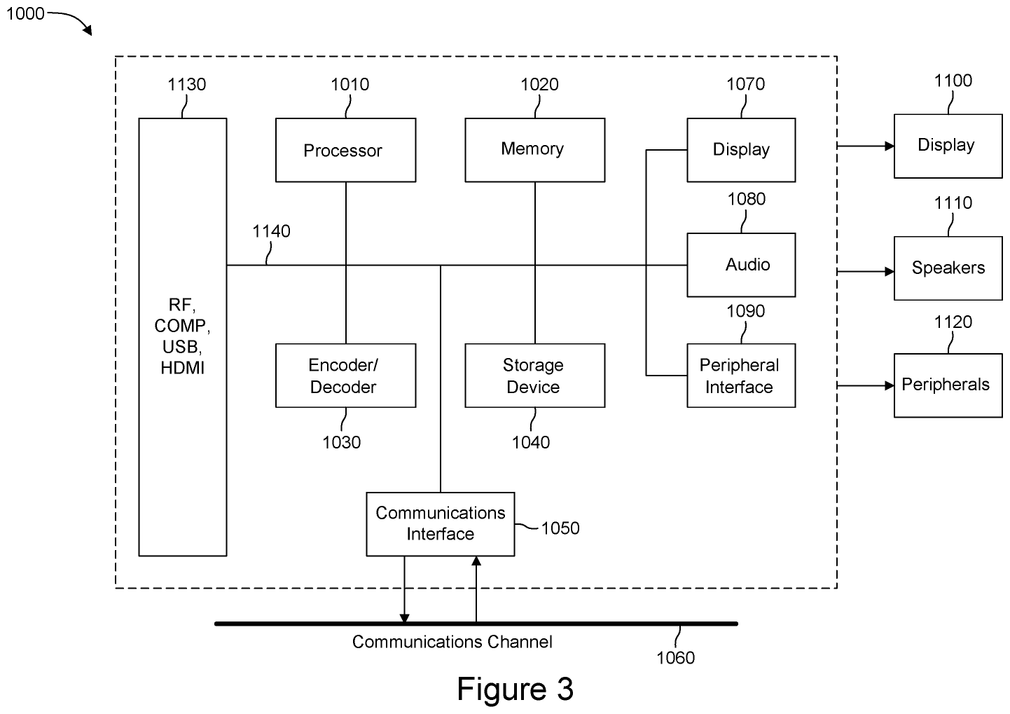

FIG. 3 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. The processor 1010 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video, or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, anew standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High-Definition Multimedia Interface (HDMI) input terminal. Other examples, not shown in FIG. 3, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other devices. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

The technical field of the embodiments is related to the intra prediction stage of a video compression scheme and is more particularly related to template matching tools. Template matching tools are based on the assumption that if the neighboring pixels of a block to be reconstructed can be found in an already reconstructed area, then there is high probably that the already reconstructed block corresponding to the matching template is similar to the block to be reconstructed. When a template matching tool is used, the device first determines, for a current block, a set of pixels forming a neighborhood of the current luma block, i.e., the pixels adjacent to the block. This set of pixels, conventionally taking the form of an L-shape, is named template. Various sizes (for example one, two or four pixels wide) may be used as a template but still based on the same principle. The process is similar on both sides. In other words, it is implemented both by the encoder device and by the decoder device. Only minor signaling elements are required to determine which template-based tool is to be used. Various template matching based tools may be used for coding and decoding a video. Some of them are described below.

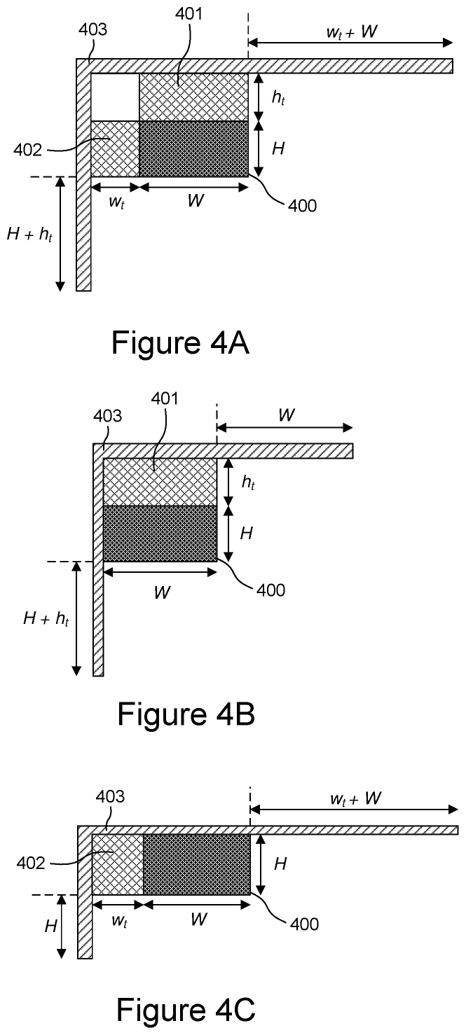

FIGS. 4A, 4B, 4C illustrate the principles of template based intra mode derivation. Template based intra mode derivation (TIMD) is a first tool based on template matching. For a given luminance coding block (CB) 400, the following modes derivation via TIMD applies the same way on the encoder and decoder sides. For each intra prediction mode in the most probable modes (MPM) list of this luminance CB, if needed supplemented with default modes, this mode computes a prediction 401, 402 of the template for this luminance CB from the decoded reference samples of the template 403, and the sum of absolute transformed differences (SATD) between this prediction and the template of this luminance CB is calculated. The two intra prediction modes with the minimum SATDs are selected as the TIMD modes. Note that, for TIMD, the set of directional intra prediction modes is extended from 65 to 129. This means that the set of possible intra prediction modes derived via TIMD gathers 131 modes. After retaining two intra prediction modes from the first pass of tests involving the MPM list supplemented with default modes, for each of these two modes, if this mode is neither PLANAR nor DC, TIMD also tests in terms of prediction SATD its two closest extended directional intra prediction modes. Note that, in the above description, it is assumed that the template of the luminance CB does not go out of the bounds of the current frame. In the case where at least one portion of the template of the luminance CB goes out of the bounds of the current frame, the template area where the prediction and SATD are computed is modified as depicted in FIGS. 4B and 4C if reconstructed left or above samples are not available respectively.

To predict the current luminance CB via TIMD, the two predictions of the luminance CB via the two TIMD modes resulting from the two passes of tests are fused with weights after applying PDPC. The used weights depend on the prediction SATDs of the two TIMD modes.

In FIG. 4A, the current W×H luminance CB (100) is surrounded by its fully available template, made of a wₜ×H portion on its left side (402) and a W×hₜ portion above it (401). During the TIMD derivation step, a tested intra prediction mode predicts the template of the current luminance CB from the set of 1+2 wₜ+2 W+2hₜ+2H decoded reference samples 403 of the template. In at least one implementation, wₜ equals 2 if W≤8, wₜ equals 4 otherwise. hₜ equals 2 if H≤8, hₜ equals 4 otherwise.

In FIG. 4B, the current W×H luminance CB (400) is surrounded by its template with only its W×hₜ portion above it (401) available. During the TIMD derivation step, a tested intra prediction mode predicts the template of the current luminance CB from the set of 1+2 W+2hₜ+2H decoded reference samples (403) of the template.

In FIG. 4C, the current W×H luminance CB (400) is surrounded by its template with only its wₜ×H portion on its left side (402) available. During the TIMD derivation step, a tested intra prediction mode predicts the template of the current luminance CB from the set of 1+2 wₜ+2 W+2H decoded reference samples (403) of the template.

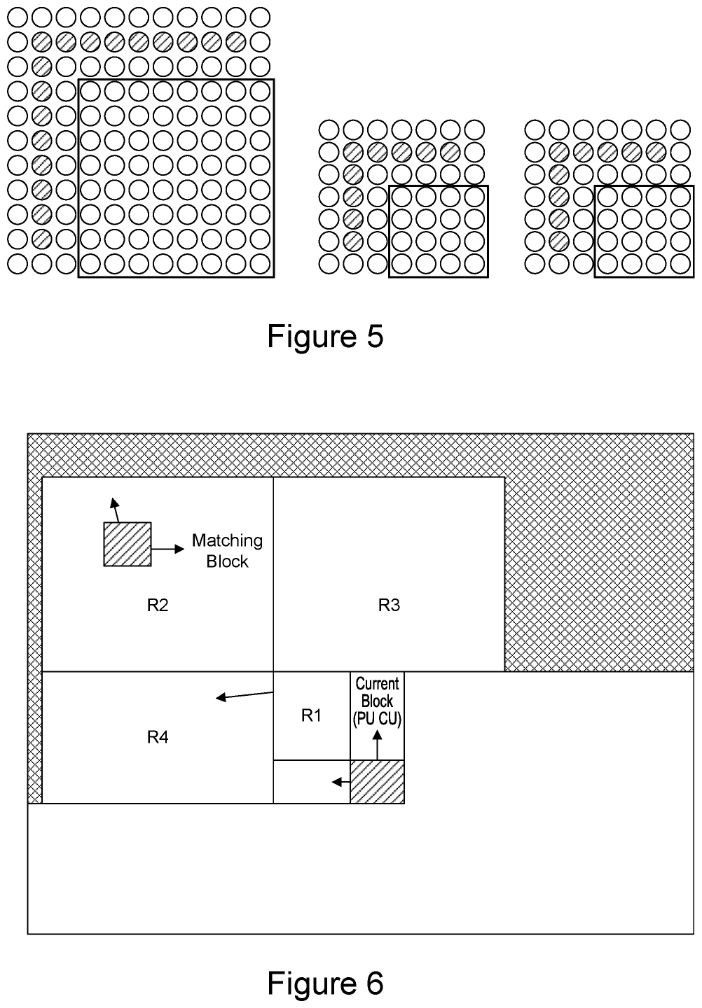

FIG. 5 illustrates the principles of decoder side intra mode derivation. Decoder side intra mode derivation (DIMD) is another tool based on template.

When DIMD is applied, two intra modes are derived from the reconstructed L-shaped templates. Basically, a histogram of gradients of the template pixels is constructed and the two peak points are selected as the angle o the prediction, and the corresponding intra modes are selected. Those two predictors are combined with the planar mode predictor with the weights derived from their histogram values. The division operations in weight derivation are performed utilizing the same lookup table (LUT) based integerization scheme used by the cross-component linear model (CCLM) prediction tool. For example, the division operation in the orientation calculation Orient=G_{y}/Gₓ is computed by the following LUT-based scheme:

$$x = Floor ( Log 2 ( {G}_{x} ) )$$

$$normDiff = ( ( {G}_{x} << 4 ) >> x ) \& 15$$

$$x += ( 3 + ( normDiff != 0 ) ? 1 : 0 )$$

$$Orient = ( {G}_{y} * ( DivSigTable [ normDiff ] \vert 8 ) + ( 1 << ( x - 1 ) ) ) >> x$$

$$Where DivSigTable [ 16 ] = \{ 0 , 7 , 6 , 5 , 5 , 4 , 4 , 3 , 3 , 2 , 2 , 1 , 1 , 1 , 1 , 0 \} .$$

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

The DIMD chroma mode uses the DIMD derivation method to derive the chroma intra prediction mode of the current block based on the neighboring reconstructed Y, Cb and Cr samples in the second neighboring row and column as shown in FIG. 5. Specifically, a horizontal gradient and a vertical gradient are calculated for each collocated reconstructed luma sample of the current chroma block, as well as the reconstructed Cb and Cr samples, to build a histogram of oriented gradients (HoG). Then the intra prediction mode with the largest histogram amplitude values is used for performing chroma intra prediction of the current chroma block.

When the intra prediction mode derived from the DIMD chroma mode is the same as the intra prediction mode derived from a direct mode, the intra prediction mode with the second largest histogram amplitude value is used as the DIMD chroma mode. A Coding Unit level flag is signaled to indicate whether the proposed DIMD chroma mode is applied.

Multi-model Based Cross-component Linear Model (MMLM) is another tool based on template analysis that extends the cross-component linear model (CCLM) prediction by adding three MMLM modes. In each MMLM mode, the reconstructed template samples are classified into two classes using a threshold which is the average of the luma reconstructed neighboring samples. The linear model of each class is derived using the Least-Mean-Square (LMS) method. For the CCLM mode using single class, the LMS method is also used to derive the linear model. A slope adjustment is applied to CCLM and to MMLM prediction. The adjustment is tilting the linear function which maps luma values to chroma values with respect to a center point determined by the average luma value of the reference samples.

FIG. 6 illustrates the principles of intra template matching. Intra template matching (Intra TMP) is another tool based on template matching. Intra TMP is a special intra prediction mode that copies the best prediction block from the reconstructed part of the current frame, whose L-shaped template matches the current template. In a predefined search range, the encoder searches for the template that is the most similar to the current template in a reconstructed part of the current frame and uses the corresponding block as a prediction block. The encoder signals the usage of this mode so that the same prediction operation is performed at the decoder side.

The prediction signal is generated by matching the L-shaped causal neighbor of the current block with another block in a predefined search area in FIG. 6 comprising 4 regions: R1 (current CTU), R2 (top-left CTU), R3 (above CTU) and R4 (left CTU). Sum of absolute differences (SAD) is used as a cost function. Within each region, the decoder searches for the template that has least SAD with respect to the current one and uses its corresponding block as a prediction block. The dimensions of the regions (SearchRange_w, SearchRange_h) are set proportional to the block dimension (BlkW, BlkH) to have a fixed number of SAD comparisons per pixel. That is:

$$SearchRange\_w = a * BlkW$$

$$SearchRange\_h = a * BlkH$$

where ‘a’ is a constant that controls the gain/complexity trade-off ‘a’ is for example equal to 5.

The Intra TMP prediction mode is enabled for CUs with size less than or equal to 64 in width and height. This maximum CU size for Intra template matching is configurable.

The Intra TMP prediction mode is signaled at CU level through a dedicated flag when DIMD is not used for current CU.

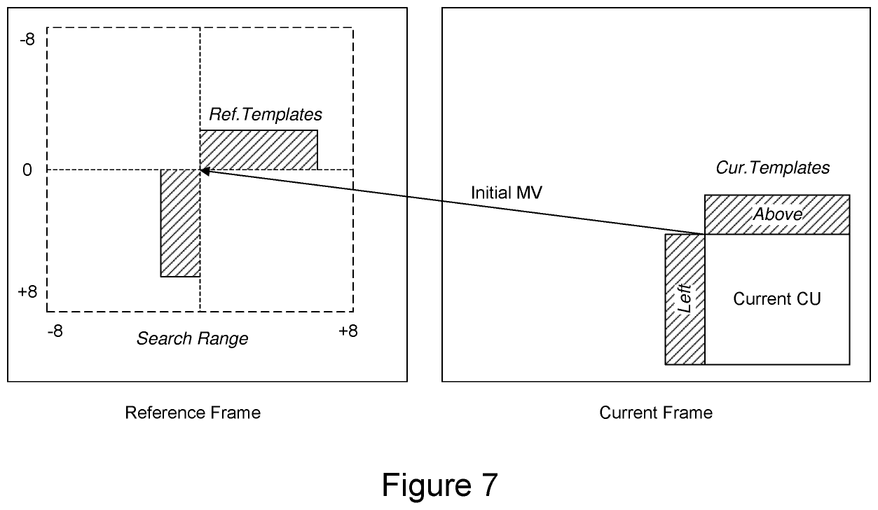

FIG. 7 illustrates the principles of template matching. Template matching (TM) is another tool based on template matching. It is a decoder-side motion vector (MV) derivation method to refine the motion information of the current CU by finding the closest match between a template of neighboring samples in the current picture and a block (i.e., same size to the template) in a reference picture. A better MV is searched around the initial motion of the current CU within a [−8, +8]-pel search range. In at least one implementation of TM, the search step size is determined based on Adaptive Motion Vector Resolution (AMVR) mode and TM can be cascaded with bilateral matching process in merge modes.

In Adaptive Motion Vector Prediction (AMVP) mode, an MVP candidate is determined based on template matching error to select the one which reaches the minimum difference between the current block template and the reference block template, and then TM is performed only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 1. This search process ensures that the MVP candidate still keeps the same MV precision as indicated by the AMVR mode after TM process. In the search process, if the difference between the previous minimum cost and the current minimum cost in the iteration is less than a threshold that is equal to the area of the block, the search process terminates.

Table 1 illustrates the search patterns of AMVR and merge modes with AMVR.

TABLE 1

| | AMVR mode | | | | Merge mode | |
|---|---|---|---|---|---|---|
| Search pattern | 4-pel | Full-pel | Half-pel | Quarter-pel | AltIF = 0 | AltIF = 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

In merge mode, a similar search method is applied to the merge candidate indicated by the merge index. As illustrated in Table 1, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

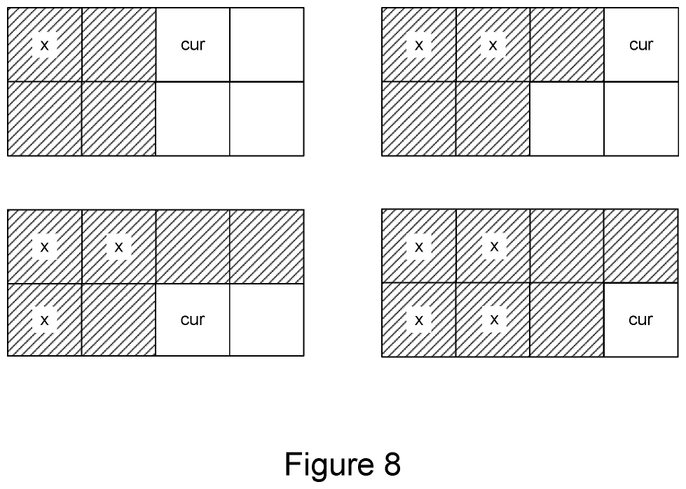

FIG. 8 illustrates the reference region restrictions for the intra block copy with template matching mode. Intra block copy with template matching mode (IBC-TM) is another tool based on template matching. Template Matching is used in IBC for both IBC merge mode and IBC AMVP mode. The IBC-TM merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC-TM merge list. Each of those 3 selected candidates are refined using the Template Matching method and sorted according to their resulting Template Matching cost. Only the 2 first ones are then considered in the motion estimation process as usual.

The Template Matching refinement for both IBC-TM merge and AMVP modes is quite simple since IBC motion vectors are constrained (i) to be integer and (ii) within a reference region. The FIG. 8 illustrates the reference region constraint for four examples of current CU positions: the regions marked with an ‘X’ sign are not considered for the refinement with regards to the current CU position.

In IBC-TM merge mode, all refinements are performed at integer precision, and in IBC-TM AMVP mode, they are performed either at integer or 4-pel precision depending on the AMVR value. Such a refinement accesses only to samples without interpolation. In both cases, the refined motion vectors and the used template in each refinement step must respect the constraint of the reference region.

Embodiments described hereafter have been designed with the foregoing in mind. Conventional template-based tools are based on the assumption that the L-shaped template captures the statistics of the current block. This assumption is utilized to deduce the best prediction mode (TIMD, DIMD), best copy block (intra template matching) or refine the merge motion vectors (inter template matching and IBC template matching). However, in some scenarios, the left or above template can be distorted for example by an edge that leads to different statistics. This typically happens when coding non-camera captured contents (gaming contents, screen contents).

Therefore, it is proposed to rely on partial templates (above or left) rather than the conventional L-shape template, in other words to consider an ‘above’ template comprising the pixels adjacent to the block and located above the block or a ‘left’ template comprising the pixels adjacent to the block and located at the left side of the block. Multiple lines or rows of pixels may also be used for the templates.

At least one embodiment proposes to allow the encoder to select, for a coding tool based on templates, the type of template amongst the ‘above’ template comprising the pixels adjacent to the block and located above the block or the ‘left’ template comprising the pixels adjacent to the block and located at the left side of the block or the combination of the ‘above’ and ‘left’ templates. In the latter case, in at least one embodiment, the template may also include the top-left elements, as it is the case in a conventional L-shape template. The type of template is signaled in the encoded data and used by the decoder to select the appropriate type of template to perform the prediction as expected using a selected template-based tool.

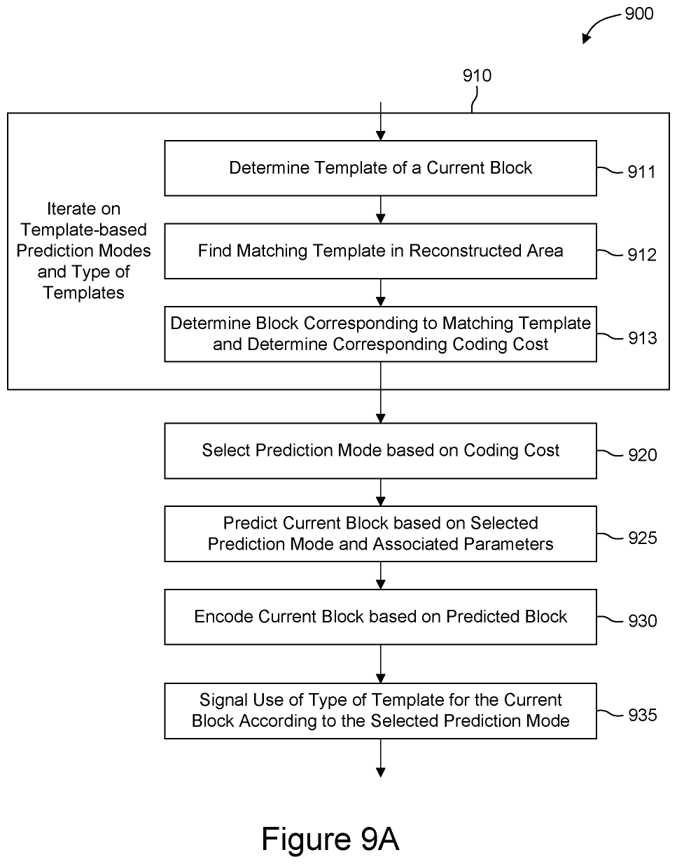

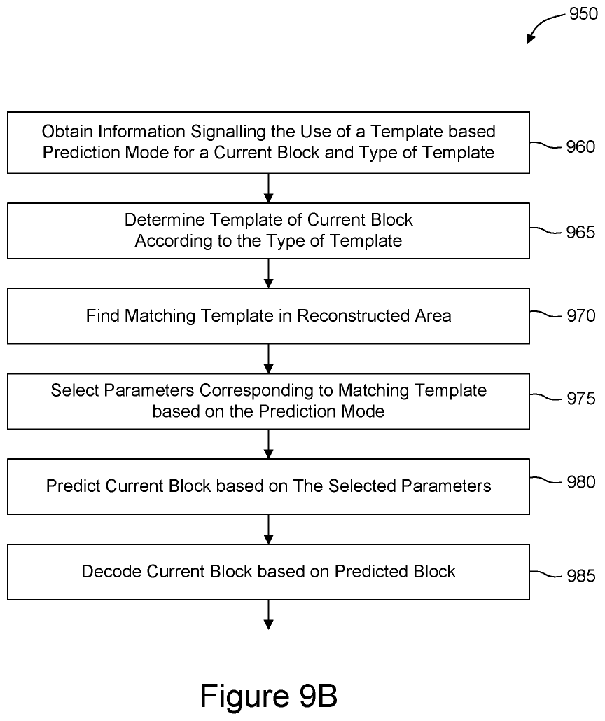

FIG. 9A illustrates a flowchart of an example of encoding process for a template-based prediction mode according to at least one embodiment. This encoding process 900 is for example implemented by an encoder 100 of FIG. 1 in a device 1000 of FIG. 3. For a current block, in step 911, the device selects a template of neighboring samples according to a type of template. The reconstructed area is analyzed in step 912 to find a template that matches the selected template. In step 913, the block corresponding to the matching template is selected and the coding cost for this block according to a template-based prediction mode is determined. Steps 911, 912, 913 are iterated for the different template-based prediction modes (with different set of parameters when available) and the different types of templates, in step 910. In step 920, a prediction mode (using a selected type of template) is selected based on coding cost. Please note that these steps 910-920 may be performed within a RDO optimization that is conventionally part of an encoder. Also, we describe here the situation where a template-based prediction mode is selected. If another mode, not using template, is selected as the prediction mode for the block, then the steps 925 to 935 are replaced by conventional encoding steps according to the selected prediction mode. In step 925, the current block is predicted according to the selected prediction and associated parameters or related data (for example: the values of the samples of the block selected for the prediction). In step 930, the current block is then encoded based on the predicted blocks and the use of the type of template is signaled for the current block according to the selected template-based prediction mode in step 935.

FIG. 9B illustrates a flowchart of an example of decoding process for a template-based prediction mode according to at least one embodiment. This decoding process 950 is implemented for example by an encoder 100 of FIG. 1 in a device 1000 of FIG. 3. In step 960, the device obtains information signaling the use of a template-based prediction mode for the current block and a type of template selected as described above. In step 965, the device determines a template of neighboring samples of the current block. In step 970, the device finds a matching (for example the best matching) template in the reconstructed area of the image and, in step 975, selects parameters corresponding to the matching template based on the prediction mode. In at least one embodiment, the set of parameters is the set of samples of the block corresponding to the matching template. These parameters are then used in step 980 to predict the current block. In step 985, the current block is then conventionally decoded (reconstructed) based on the predicted blocks.

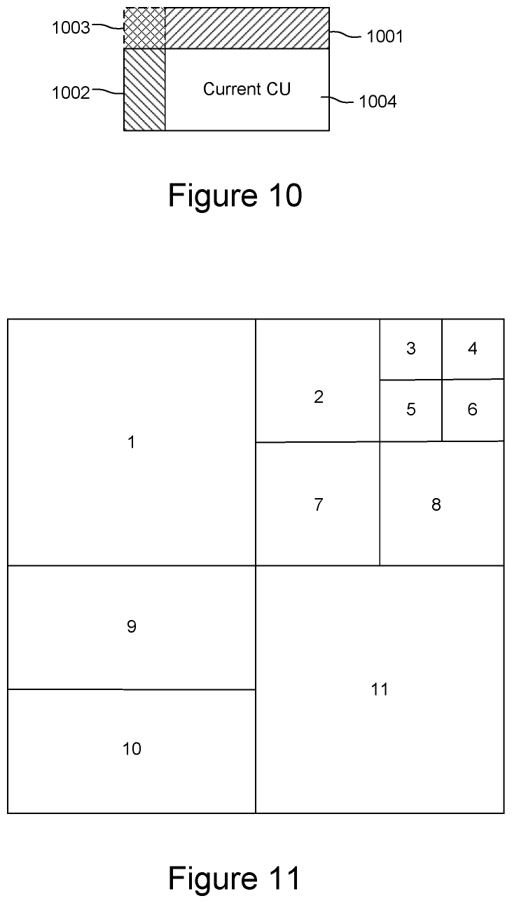

FIG. 10 illustrates the type of templates. The element 1004 represents the current coding unit. It is surrounded by the above template 1001 and the left template 1002 that are adjacent to the CU. The conventional ‘L-shape’ may be obtained by combining the above template 1001 and the left template 1002 with the top-left region 1003. Templates represented in this figure are multiple pixels wide (or tall), however the templates described in this document may also be single pixel width (or height) templates.

In at least one embodiment, in addition to at least a first element signaling the usage of a template-based tool, an additional syntax element is signaled to represent the type of template is used by the template-based tool, selected amongst above template, left template or both templates. This signaling may be done at high level SPS, or slice header, or at CU level for example. It is generated by the encoder device for a block of image of the video and provided through an encoded stream to the decoding device to enable a correct reconstructing of the encoded block of the image of the video. A binary form of this signaling is illustrated in table 2.

TABLE 2

| Template type | Binarization |
|---|---|
| Above and left templates | 0 |
| Above template | 10 |
| Left template | 11 |

In at least one embodiment, the syntax element representing the type of template is optimized to reduce the signaling overhead. In the case of non-square blocks, it is less probable to use the left template for wide blocks (width larger than height), since more elements are available in the upper template. Similarly, it is less probable to use the above template for thin blocks. Therefore, it is proposed in at least one embodiment to use a single bit signaling to indicate if the above and left templates are used or if only one of them is used. The choice between the above or the left template is done based on the block shape: above for wide blocks and left template for tall/narrow blocks. For square blocks, by default the above template is used. A binary form of this signaling is illustrated in table 3.

TABLE 3

| Template type | Binarization |
|---|---|
| Above and left templates | 0 |
| Above or Left template selected | 1 |
| according to CU proportions | |

In a variant embodiment, the signaling form of table 3 is used only in the case the proportion of the block respect a certain condition, for example only if the ratio of the width divided by the height if width greater than height or the ratio of the height divided by the width if height greater than width is superior to a pre-determined threshold.

In another variant illustrated in FIG. 10, when the above template 1001 and the left template 1002 are used, the template also includes the top-left region 1003 so that the template is a ‘L-shape’.

In another variant, the templates are not limited to a single line but uses multiple lines, for example the above template uses multiple rows of pixels, and the left template uses multiple columns of pixels.

FIG. 11 illustrates an example of CTU partitioning with the CUs decoding order. It illustrates the latency issue for the Template Matching (TM) prediction mode.

At least one embodiment proposes to reduce the latency induced by the TM prediction mode by signaling the template used. Indeed, TM induces some latency in the decoding of CUs because, it needs that the surroundings reconstructions are completed to be able to calculate the current template for a particular CU. For example, the current template of the 8th CU needs to wait for the complete reconstruction of the 5th, 6th, and 7th CUs. So, until the 7th CU is not completely reconstructed, the process of the 8th CU cannot start.

In general, the ‘above’ CUs are available, but the ‘left’ ones may be missing. In this embodiment, it is proposed to signal at SPS, picture header or slice header level, if both (left and above) templates or only above template can be used for TM. The latter case allows to overcome the TM latency issue.

In a variant embodiment, as some CUs do not suffer of such latency issue (e.g.: the 7^{th}CU in the figure needs the reconstruction of the first and second CUs), it is proposed to signal the usage of above template, or left template or both templates at the CU level. For example, 2, 3, 4, 6, 8 and 11 use above; 10 uses left; and 1, 5, 7, 9 use both.

In another variant, to keep the CTUs independent, it is proposed to signal if above template, or left template, or both templates, or no template can be used for each CU. For example, 1, 2, 3, 4 and 10 use none; 6, 8, 9 and 11 use above; and 5 and 7 use both.

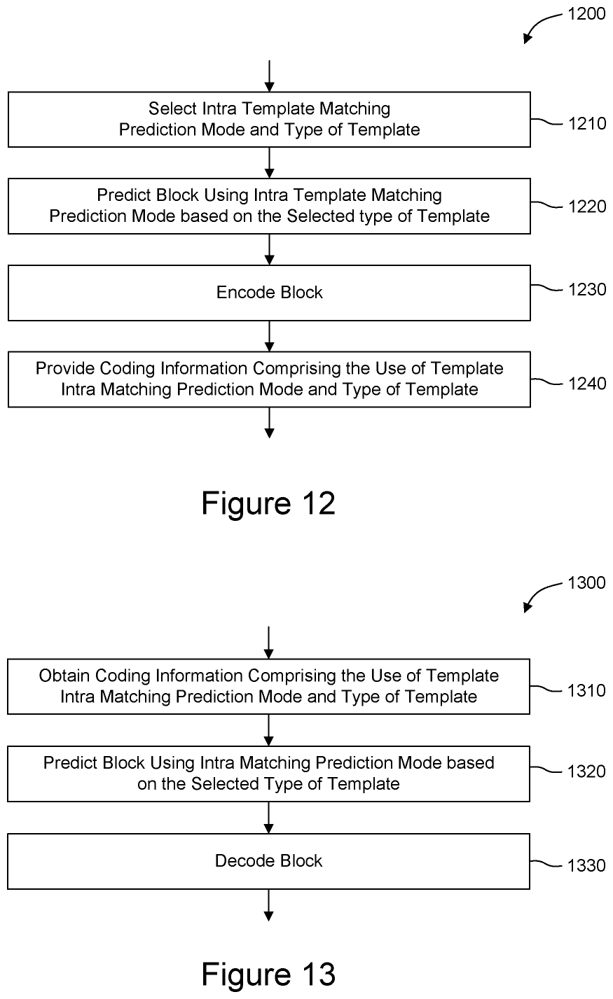

FIG. 12 illustrates a flowchart of an example of encoding process using an intra template matching prediction mode according to at least one embodiment. This encoding process 1200 is for example implemented by an encoder 100 of FIG. 1 in a device 1000 of FIG. 3. The process is operated on a current block of an image or video. In step 1210, the encoder selects an intra template matching prediction mode and type of template for a current block. In step 1220, the encode predicts a block using the intra template matching prediction mode based on the type of template. In step 1230, the encoder encodes the predicted block. In step 1240, the encoder provides coding information for the current block comprising at least the use of template intra matching prediction mode and type of template.

FIG. 13 illustrates a flowchart of an example of decoding process using an intra template matching prediction mode according to at least one embodiment. This decoding process 1300 is for example implemented by a decoder 200 of FIG. 2 in a device 1000 of FIG. 3. The process is operated on a current block of an image or video. In step 1310, the decoder obtains coding information for the current block comprising at least the use of template intra matching prediction mode and type of template. In step 1320, the decoder predicts a block using the intra template matching prediction mode based on the type of template. In step 1330, the decoder decodes the predicted block.

At least one example of an embodiment can involve a device including an apparatus as described herein and at least one of (i) an antenna configured to receive a signal, the signal including data representative of the image information, (ii) a band limiter configured to limit the received signal to a band of frequencies that includes the data representative of the image information, and (iii) a display configured to display an image from the image information.

At least one example of an embodiment can involve a device as described herein, wherein the device comprises one of a television, a television signal receiver, a set-top box, a gateway device, a mobile device, a cell phone, a tablet, a computer, a laptop, or other electronic device.

In general, another example of an embodiment can involve a bitstream or signal formatted to include syntax elements and picture information, wherein the syntax elements are produced, and the picture information is encoded by processing based on any one or more of the examples of embodiments of methods in accordance with the present disclosure.

In general, one or more other examples of embodiments can also provide a computer readable storage medium, e.g., a non-volatile computer readable storage medium, having stored thereon instructions for encoding or decoding picture information such as video data according to the methods or the apparatus described herein. One or more embodiments can also provide a computer readable storage medium having stored thereon a bitstream generated according to methods or apparatus described herein. One or more embodiments can also provide methods and apparatus for transmitting or receiving a bitstream or signal generated according to methods or apparatus described herein.

Many of the examples of embodiments described herein are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the embodiments, features, etc. can be combined and interchanged with others described in earlier filings as well.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

In general, the examples of embodiments, implementations, features, etc., described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. One or more examples of methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users. Also, use of the term “processor” herein is intended to broadly encompass various configurations of one processor or more than one processor.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Various embodiments are described herein. Features of these embodiments can be provided alone or in any combination, across various claim categories and types.

1-13. (canceled)

14. A decoding method comprising, for a current block of a picture,
obtaining coding information for the current block comprising at least an information representative of a use of an intra template matching prediction mode and a single bit information representative of a type of template;
when the single bit information representative of a type of template has a first value, determining a template of neighboring samples as comprising a line of pixels adjacent to the current block and located above the current block and a column of pixels adjacent to the current block and located at a left side the current block;
when the single bit information representative of a type of template has a second value, if a height of the current block is greater than a width of the current block, determining a template of neighboring samples as comprising a column of pixels adjacent to the current block and located at the left side the current block, else determining a template of neighboring samples as comprising a line of pixels adjacent to the current block and located above the current block;
predicting a block using an intra template matching prediction mode based on the determined template of neighboring samples; and
decoding current block based on the predicted block.

15. The method of claim 14, further comprising verifying that proportions of the current block respect a ratio condition when the single bit information representative of a type of template has the second value.

16. The method of claim 15, wherein the ratio condition is that, when the width of the current block is greater than the height of the current block, the ratio of the width of the current block divided by the height of the current block is greater than a pre-determined threshold and when the height of the current block is greater than the width of the current block, the ratio of the height of the current block divided by the width of the current block is greater than a pre-determined threshold.

17. The method of claim 14, wherein when the single bit information representative of a type of template has a first value, the template of neighboring samples also comprises a pixel located at an intersection between the line of pixels adjacent to the current block and located above the current block and the column of pixels adjacent to the current block and located at a left side the current block.

18. The method of claim 14, wherein the template of neighboring samples comprises multiple lines or columns.

19. The method of claim 14, wherein the first value is zero and the second value is one.

20. A device comprising a processor configured to, for a current block of a picture:
obtain coding information for the current block comprising at least an information representative of a use of an intra template matching prediction mode and a single bit information representative of a type of template;
when the single bit information representative of a type of template has a first value, determine a template of neighboring samples as comprising a line of pixels adjacent to the current block and located above the current block and a column of pixels adjacent to the current block and located at a left side the current block;
when the single bit information representative of a type of template has a second value, if a height of the current block is greater than a width of the current block, determine a template of neighboring samples as comprising a column of pixels adjacent to the current block and located at the left side the current block, else determine a template of neighboring samples as comprising a line of pixels adjacent to the current block and located above the current block;
predict a block using an intra template matching prediction mode based on the determined template of neighboring samples; and
decode current block based on the predicted block.

21. The device of claim 20, wherein the processor is configured to verify that proportions of the current block respect a ratio condition when the single bit information representative of a type of template has the second value.

22. The device of claim 21, wherein the ratio condition is that, when the width of the current block is greater than the height of the current block, the ratio of the width of the current block divided by the height of the current block is greater than a pre-determined threshold and when the height of the current block is greater than the width of the current block, the ratio of the height of the current block divided by the width of the current block is greater than a pre-determined threshold.

23. The device of claim 20, wherein when the single bit information representative of a type of template has a first value, the template of neighboring samples also comprises a pixel located at an intersection between the line of pixels adjacent to the current block and located above the current block and the column of pixels adjacent to the current block and located at the left side the current block.

24. The device of claim 20, wherein the template of neighboring samples comprises multiple lines or columns.

25. The device of claim 20, wherein the first value is zero and the second value is one.

26. A non-transitory computer-readable storage medium having stored instructions that, when executed by a processor, cause the processor to decode a current block of a picture, comprising:
obtaining coding information for the current block comprising at least an information representative of a use of an intra template matching prediction mode and a single bit information representative of a type of template;
when the single bit information representative of a type of template has a first value, determining a template of neighboring samples as comprising a line of pixels adjacent to the current block and located above the current block and a column of pixels adjacent to the current block and located at a left side the current block;
when the single bit information representative of a type of template has a second value, if a height of the current block is greater than a width of the current block, determining a template of neighboring samples as comprising a column of pixels adjacent to the current block and located at the left side the current block, else determining a template of neighboring samples as comprising a line of pixels adjacent to the current block and located above the current block;
predicting a block using an intra template matching prediction mode based on the determined template of neighboring samples; and
decoding current block based on the predicted block.
